(19) United States
(12) Patent Application Publication
(10) Pub. No.: US 2007/0000318 A1
(43) Pub. Date: Jan. 4, 2007

(54) Fuel level gauge for a motorcycle

(75) Inventors: Tony Nicosia, Brookfield, WI (US); Craig R. DeRuyter, Belgium, WI (US)

Correspondence Address: MICHAEL BEST & FRIEDRICH, LLP, 100 E WISCONSIN AVENUE, MILWAUKEE, WI, 53202, US

(73) Assignee: Harley-Davidson Motor Company Group, Inc., Milwaukee, WI (US)

(21) Appl. No.: 11/173,180

(22) Filed: Jul. 1, 2005

(51) Int. Cl. G01F 23/00

(52) U.S. Cl. 73/290 R

(57) ABSTRACT

A fuel level gauge assembly for a motorcycle having a fuel tank containing fuel at a level. The fuel level gauge includes light emitting diodes (LEDs) indicating to a rider the quantity of fuel remaining in the tank. A mirrored lens on the top of the gauge hides the LEDs when the LEDs are not illuminated. The fuel level gauge includes a pop-up feature allowing it to be removed from the fuel tank without the use of tools. When assembled to the tank and in a retracted position, the top surface of the fuel level gauge is substantially aligned with the top surface of the fuel tank.

### BACKGROUND

The present invention relates to motorcycle fuel tank assemblies, and particularly to fuel level gauges for motorcycle fuel tanks.

A feature common to many older motorcycles is a fuel tank assembly having dual symmetrical tanks placed side by side. The purpose of this was to provide for a reserve of fuel should one tank be completely emptied. Having dual tanks necessitated having a fuel filler cap on each tank. The filler caps were normally placed symmetrically on the top of the tanks. As technology developed, the use of a fuel level gauge eliminated the need for a second or reserve fuel tank. However, riders had become accustomed to the appearance of two fuel filler caps on their bikes, and were interested in maintaining the same vintage look. To maintain the look of dual filler caps, manufacturers began placing a “dead” filler cap on one side of the tanks, and more recently, a fuel gauge resembling a filler cap has been used in place of the “dead” filler cap.

Known fuel gauges resemble filler caps in that they each include a circular top surface and a generally cylindrical side wall extending downwardly from the edge of the top surface toward the exterior surface of the tank. One known type of fuel gauge includes a needle gauge visible through a window in the top surface of the gauge. Another known type of fuel gauge includes a series of light emitting diodes (“LED”) located on the side wall of the fuel gauge.

### SUMMARY

The present invention provides a fuel gauge assembly for a motorcycle having a fuel tank containing fuel at a level. The fuel gauge assembly includes a housing that defines an axis and that is adapted to be coupled to the fuel tank of the motorcycle. The fuel gauge is adapted to indicate the level of fuel in the tank and is movable along the axis and relative to the housing between retracted and extended positions. The fuel gauge is a first distance from the housing in the retracted position, and the fuel gauge is a second greater distance from the housing in the extended position. The fuel gauge is released from the retracted position toward the extended position by moving the fuel gauge along the axis toward the housing.

The invention also provides a motorcycle fuel tank assembly. The fuel tank assembly includes a fuel tank including a top surface and an aperture located in the top surface. The top surface defines a first contour. The fuel tank is adapted to contain fuel at a level and a fuel gauge is adapted to indicate the level of fuel within the fuel tank. The fuel gauge includes a top surface defining a second contour. The fuel gauge is coupled to the fuel tank and received within the aperture such that the top surface of the fuel tank is substantially aligned with the top surface of the fuel gauge and the first contour matches the second contour.

The invention also provides a fuel gauge assembly for a motorcycle including a fuel tank adapted to contain fuel at a level. The motorcycle is adapted to be driven by a rider. The fuel gauge assembly is adapted to be coupled to the fuel tank of the motorcycle and indicate the level of fuel in the fuel tank. The fuel gauge assembly includes a top surface and at lease one light emitting diode (“LED”) including an illuminated condition and a non-illuminated condition. The LED emits light through the top surface of the fuel gauge when the LED is in the illuminated condition and the emitted light is adapted to be visible to the rider of motorcycle.

Other aspects of the invention will become apparent by consideration of the detailed description and accompanying drawings.

### BRIEF DESCRIPTION OF THE DRAWINGS

FIG. 1 is a perspective view of a fuel tank assembly for a motorcycle including a fuel level gauge assembly embodying the present invention.

FIG. 2 is an exploded perspective view of the fuel level gauge assembly of FIG. 1.

FIG. 3 is a top view of a housing of the fuel level gauge assembly of FIG. 2.

FIG. 4 is a top view of a fuel level gauge of the fuel level gauge assembly of FIG. 2, illustrating a series of LEDs and a photoelectric sensor.

FIG. 5 is a perspective view of the fuel level gauge assembly of FIG. 1, illustrating the fuel level gauge being moved toward the housing.

FIG. 6 is a plan view of a groove on a side of the fuel level gauge of FIG. 2, illustrating an initial path of a biased pin of the fuel level gauge assembly corresponding to a first movement of the fuel level gauge toward the housing, such as during assembly of the fuel level gauge into the housing.

FIG. 7 is a view similar to FIG. 5, illustrating the fuel level gauge in a retracted position.

FIG. 8 is a view similar to FIG. 6, illustrating a subsequent path of the biased pin corresponding to movement of the fuel level gauge to the retracted position.

FIG. 9 is a view similar to FIG. 8, illustrating a subsequent path of the biased pin corresponding to a second movement of the fuel level gauge toward the housing.

FIG. 10 is a view similar to FIG. 7, illustrating the fuel level gauge in an extended position.

FIG. 11 is a view similar to FIG. 9, illustrating a subsequent path of the biased pin corresponding to movement of the fuel level gauge to the extended position.

FIG. 12 is a view similar to FIG. 7, illustrating some of the LEDs in an illuminated condition.

FIG. 13 is a perspective view of a motorcycle including the fuel tank assembly of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

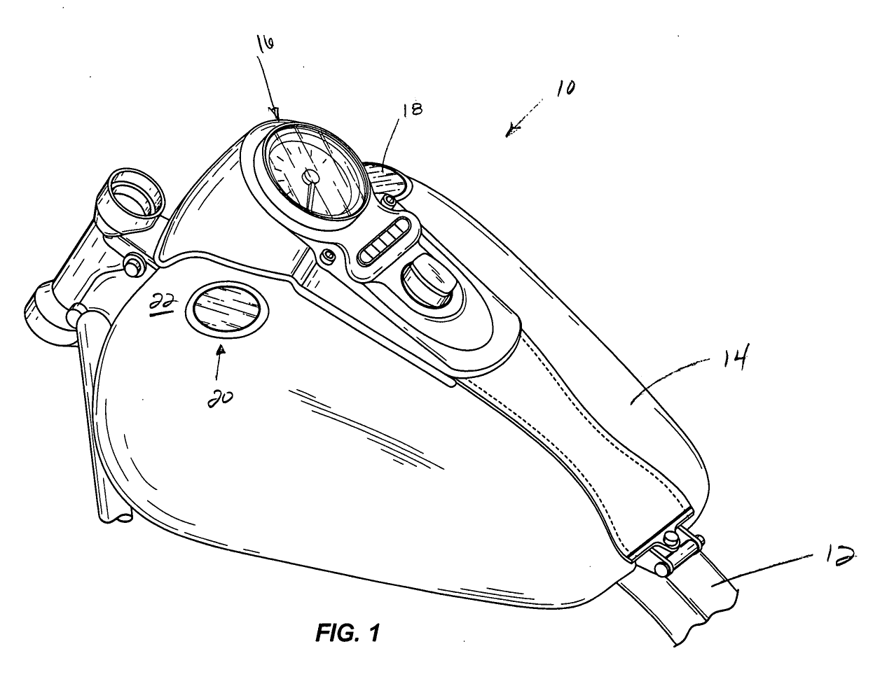

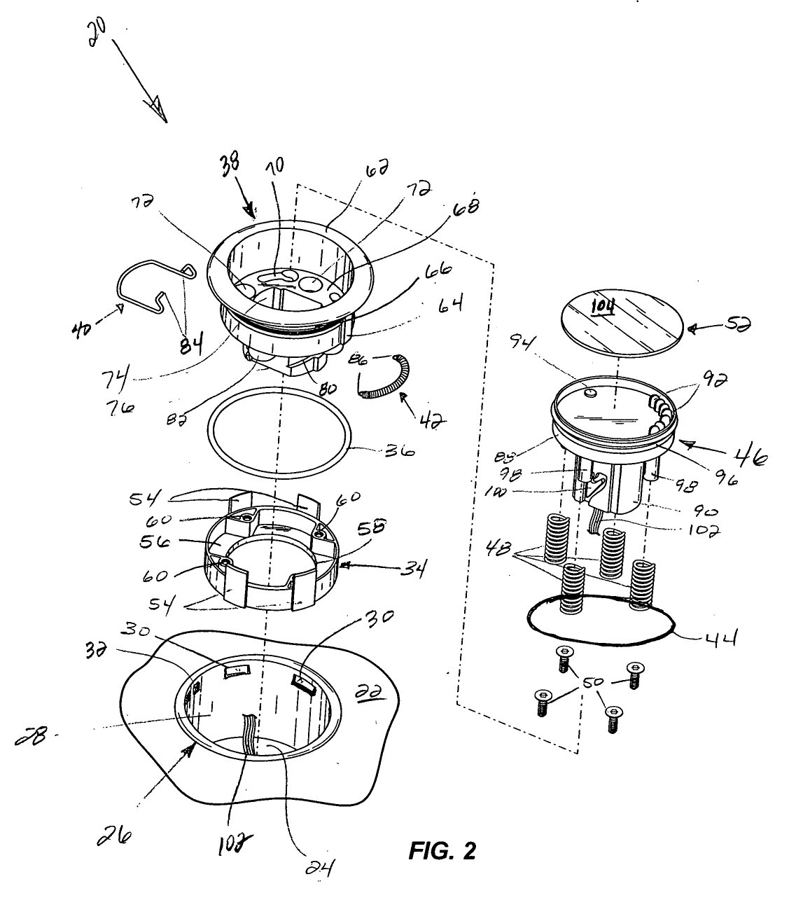

FIG. 1 illustrates a fuel tank assembly 10 for a motorcycle that includes a frame 12. The fuel tank assembly 10 includes a fuel tank 14 coupled to the frame 12, a speedometer assembly 16 mounted in the center of the fuel tank 14, a fuel filler cap 18, and a fuel level gauge assembly 20. The fuel filler cap 18 and fuel level gauge assembly 20 are generally placed symmetrically on either side of the tank 14. The fuel tank 14 includes an aperture (not shown) in the top surface 22 that provides access to the internal cavity 24 (FIG. 2) of the fuel tank where fuel is stored. The fuel filler cap 18 is removably coupled to the fuel tank 14 to cover the aperture and selectively provide access to the tank cavity 24.

As shown in FIG. 2, the fuel tank 14 also includes a fuel tank cup 26 that is recessed below the top surface 22 of the fuel tank 14. The top surface 22 of the tank 14 around the fuel tank cup 26 defines a smooth contour. The fuel tank cup 26 includes a cylindrical wall 28 that extends into the cavity 24 of the tank 14. The cylindrical wall 28 includes four wide protrusions 30 (only two shown) that extend inwardly away from the wall 28 and that are circumferentially spaced apart from each other. The cylindrical wall 28 also includes two pairs of narrow protrusions 32. Each pair includes two narrow protrusions 32 that are spaced closely together. The first pair of narrow protrusions 32 is located toward the front of the motorcycle, and the second pair of protrusions (not shown) is located toward the rear of the motorcycle and are spaced farther apart than the first pair 32.

Referring to FIG. 2, the fuel level gauge assembly 20 includes a retaining ring 34, a housing o-ring 36, a housing 38, a biased pin 40 and a retaining spring 42, a fuel level gauge o-ring 44, a fuel level gauge 46, springs 48, retaining screws 50, and a mirrored lens 52. On the outside surface of the plastic retaining ring 34 are four raised tabs 54. The tabs 54 are circumferentially spaced, and extend upwards from the ring 34. A planar surface 56 exists in the interior of the ring 34, which contains a round aperture 58 centered in relation to the ring 34. On the planar surface 56 and spaced circumferentially about the aperture 58 are four bosses 60 designed to accept threaded fasteners.

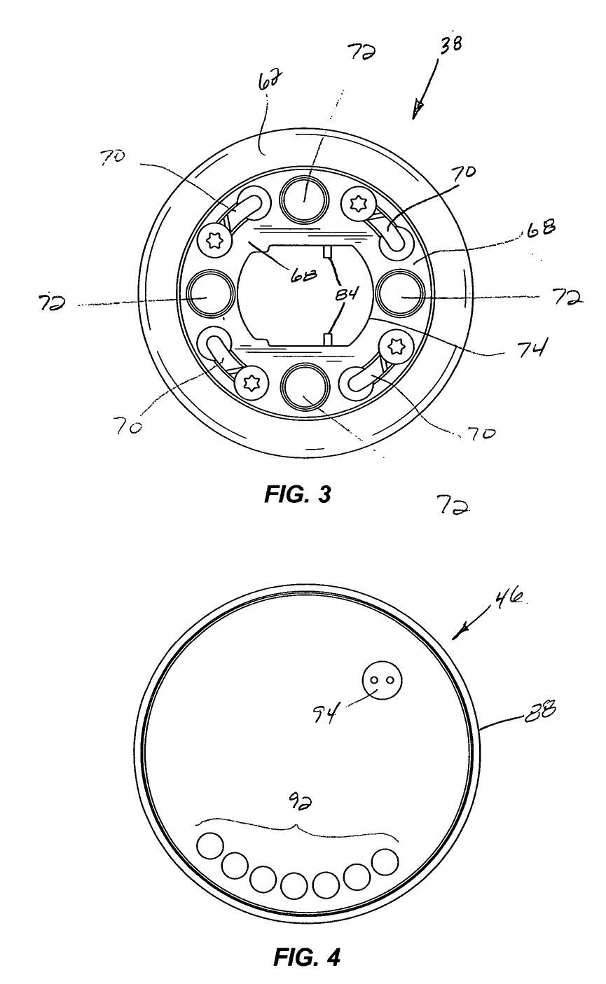

FIG. 3 shows a top view of the housing 38, including the housing's trim ring 62. The chrome-plated metal housing 38 is generally cylindrical including two protrusions on the outside surface. A narrow protrusion exists on the front side (not shown) and a wider protrusion 64 exists on the backside (FIG. 2). These protrusions match the spaces between the protrusions on the inside surface of the fuel tank cup 26. Just above these protrusions on the housing 38 is a circumferential groove 66 where the housing o-ring 36 is seated. Inside the housing 38 is a planar surface 68, which contains a set of four screw slots 70, four spring seats 72, and a non-symmetrical aperture 74 in the center. The screw slots 70 and spring seats 72 alternate in an arcuate pattern around the aperture 74. The trim ring 62 forms the top surface of the housing 38, and also defines a top contoured surface slightly above the top surface 22 of the fuel tank 14 when the fuel level gauge 46 is installed.

The underside of the housing 38 is planar except for a projection 76, the inside of which generally matches the profile of the non-symmetrical aperture 74. The projection 76 is substantially flat on three sides and curved on the fourth side. There is a groove 80 on the projection 76 for the retaining spring 42 to rest in (partially shown in FIG. 2). The biased pin 40 also rests in a groove (not shown) on the projection. There are holes 82 through the two opposing flat sides.

The biased pin 40 is made of metal, and is essentially a wire bent to a specific symmetric shape. The pin 40 has a curved portion surrounded by two straight portions, or legs, on either side. This generally matches the profile of the projection 76 on the underside of the housing 38. At the ends of the straight sides, the pin 40 bends upwards sharply and then in towards the center. The two ends 84 of the pin are thus pointed roughly towards each other, but not touching. The retaining spring 42 is a coiled spring that has a closed loop 86 on each of its ends.

The fuel level gauge 46 includes a top cylindrical portion 88 and a protrusion 90 extending from the underside of the top cylindrical portion 88. FIG. 4 shows the top portion 88, which is chrome-plated metal. The top of the fuel level gauge 46 contains a series of seven light emitting diodes (LEDs) 92 in an arcuate pattern along the bottom edge, as well as an photoelectric sensor 94. The side of the cylindrical portion 88 contains a circumferential groove 96 designed to seat the fuel level gauge o-ring 44.

On the bottom surface of the fuel level gauge 46 are four protruding spring guides 98. Each of these protrusions 98 will fit inside one of the four springs 48. The protrusion 90 in the center has a profile matching that of the non-symmetrical aperture 74 in the housing 38. This protrusion 90 contains a groove 100 on each side. The groove includes multiple tracks that form a closed circuit. From the bottom of the protrusion 90, a group of electrical wires 102 extend downward to be connected to the motorcycle's fuel level sensor (not shown) positioned within the fuel tank 14.

The mirrored lens 52 is a thin, round disk made from glass or a high-impact plastic. It has a chrome plated finish. The lens 52 appears to be chrome plated metal, but it allows light to travel through it. The lens 52 is mounted to the top of the fuel level gauge 46, covering the LEDs 92 and photoelectric sensor 94. The lens 52 has a top surface 104 that defines a smooth contour.

The first step in assembling this system is to place the housing o-ring 36 into its groove 66 around the outside of the housing 38. This will seal the housing 38 against the top surface 22 of the fuel tank 14, which will protect the inside of the fuel tank 14 from moisture and debris. Following this, the biased pin 40 can be placed into its groove in the housing's lower projection 76. When the pin 40 is in position and wrapped around the projection 76, the two ends 84 will protrude through the holes 82 in the flat sides of the projection 76. The loops 86 at the ends of the retaining spring 42 are placed over the ends of the biased pin 40 and moved back to the sharp upward curves on each leg of the pin 40. The retaining spring 42 is then stretched around the remainder of the projection 76 on the underside of the housing 38, allowing the retaining spring 42 to bias the pin ends 84 toward the direction of the spring 42. When assembled, the biased pin 40 and retaining spring 42 combination will wrap around the perimeter of the lower projection 76 of the housing 38.

To attach the retaining ring 34 to the housing 38, it must first be placed underneath the housing 38 so that the four bosses 60 on the retaining ring 34 align with the four screw slots 70 on the planar section 68 of the housing 38. When in this position, the four screws 50 are placed in the slots 70 and then screwed loosely into the bosses 60 in the retaining ring 34 positioned below. The housing 38 and retaining ring 34 are then placed into the fuel tank cup 26 in such a way that the wide protrusion 64 on the back of the housing 38 fits between the widely spaced tabs (not shown) in the rear of the cup 26, and the narrow protrusion (not shown) on the front of the housing 38 fits between the narrow tabs 32 in the front of the cup 26. When in this position, the four raised tabs 54 on the retaining ring 34 will fall between the four protrusions 30 on the inside wall 28 of the tank cup 26. The screws 50 and retaining ring 34 are rotated clockwise with respect to the housing 38 so that the countersunk heads on the screws 50 line up with the countersinks at the end of each arcuate slot 70 in the housing's planar surface 68. This action also aligns the raised tabs 54 on the retaining ring 34 underneath the protrusions 30 on the wall 28 of the tank cup 26. When the screws 50 are tightened the retaining ring 34 will be drawn toward the housing 38. The four raised tabs 54 on the retaining ring 34 will push against the four protrusions 30 in the tank cup 26 and the housing's trim ring 62 will push against the o-ring 36 and the top surface 22 of the fuel tank 14. The installed housing 38 resists rotation and removal from the cup 26 when the screws 50 are tightened.

Before the fuel level gauge 46 is placed into the housing 38, the fuel level gauge o-ring 44 is placed into the circumferential groove 96 on the top cylindrical portion 88. The four springs 48 are placed over the spring guides 98 protruding from the bottom of the fuel level gauge 46. As the fuel level gauge 46 is placed into the housing 38, the electrical wires 102 must be fed into the fuel tank 14 through the aperture 74 in the housing 38 and through the aperture 58 in the retaining ring 34 below the housing 38. The wires 102 are connected to the motorcycle's fuel level sensor (not shown). The protrusion 90 from the underside of the fuel level gauge 46 shares the same profile as the aperture 74 in the housing 38, and they are designed to provide a sliding fit between the fuel level gauge 46 and the housing 38. The housing aperture 74 is of a shape permitting the fuel level gauge 46 to be installed in only one direction. When the fuel level gauge 46 is installed, the four spring guides 98 are aligned with the four spring seats 72 in the housing 38, and the springs 48 will rest in these seats 72 and provide a force that biases the fuel level gauge 46 away from the housing 38.

Upon installing the fuel level gauge 46 in the housing 38, the two biased pin ends 84 will enter the grooves 100 on either side of the fuel level gauge 46. The biased pin ends 84 have a circuit of multiple tracks to follow while in the grooves 100. As the pin ends 84 follow these tracks, it allows the fuel level gauge 46 to “pop up” from a retracted position to an extended position, and then back to the retracted position. Assuming the fuel level gauge 46 is starting in the extended position, moving it toward the housing 38 will cause the biased pin end 84 to follow a first track 106. When the fuel level gauge 46 cannot be moved further toward the housing 38, it is released and the springs 48 force the fuel level gauge 46 away from the housing 38 to the retracted position. During this motion, the biased nature of the pin end 84 forces it around the corner into a recess along a second track 108. If the fuel level gauge 46 is not moved toward the housing 38 again, the pin end 84 will be held in the recess, and the fuel level gauge 46 will be held in the retracted position. When the fuel level gauge 46 is moved toward the housing 38 from the retracted position, the biased pin end 84 is forced to follow a third track 110. After the fuel level gauge 46 cannot be moved further toward the housing. 38, the fuel level gauge 46 is released and the pin end 84 moves along a fourth track 112 allowing the fuel level gauge 46 to be released back to the extended position.

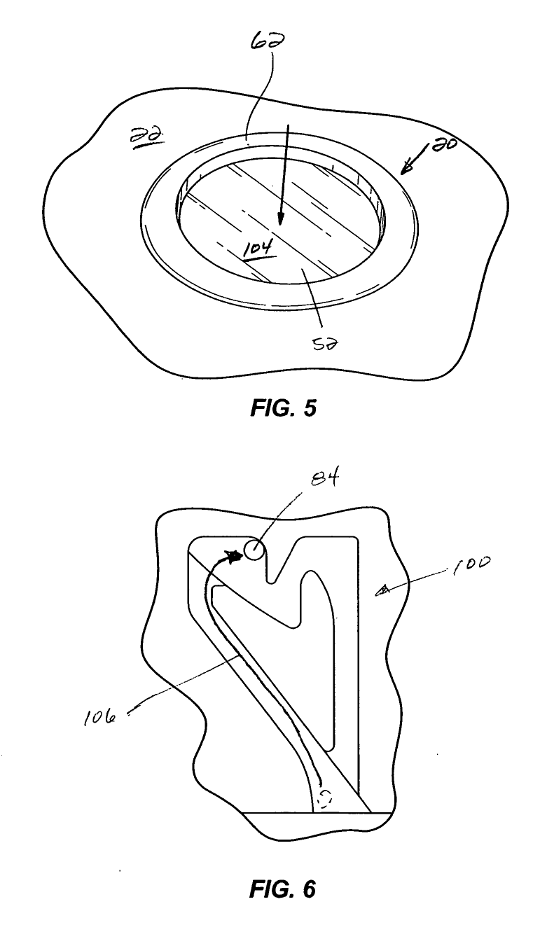

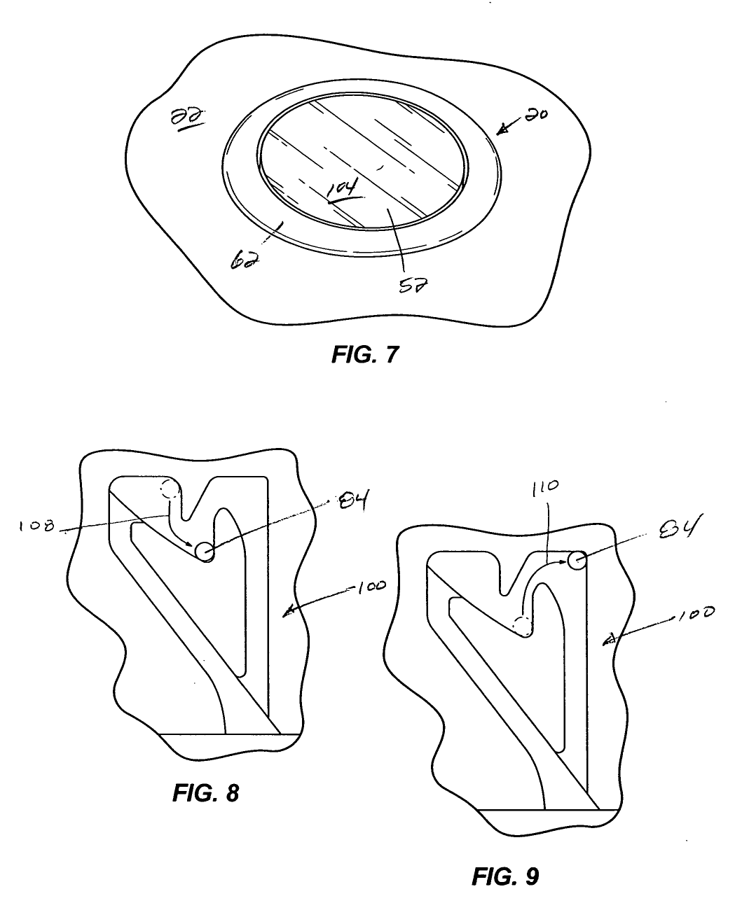

FIGS. 5-8 illustrate the fuel level gauge 46 being transferred from an extended position to a retracted position. Assuming the fuel level gauge 46 has started in the extended position, pressing it towards the housing 38 will result in the fuel level gauge 46 being positioned as shown in FIG. 5. FIG. 6 shows the travel path of the pin end 84 along the first track 106 in the pop-up groove 100 corresponding to the position of the fuel level gauge 46 in FIG. 5. Upon release of the gauge 46, it will move to the retracted position (FIG. 7). The top surface 104 of the lens 52 will be substantially aligned with the top surface of the trim ring 62, and the pin end 84 will settle to the position in the pop-up groove 100 (FIG. 8) after traveling along the second track 108.

In the retracted position, the top surface 104 of the lens 52 is aligned with the top surfaces of the trim ring 62 and the top surface 22 of the tank 14 such that the contour of the lens 52 matches the contours of the trim ring 62 and tank 14. As used herein, surfaces are aligned and contours match when the adjacent surfaces transition substantially smoothly between each other. As an example, fuel gauges of the prior art included a substantially cylindrical side wall that provided the appearance of a gripping surface similar to the gas filler cap. The gripping surface would be considered an abrupt transition between the tank top surface and the fuel gauge top surface, and therefore the top surfaces of the fuel gauge and the tank would not be aligned nor would the respective contours be considered to be matching.

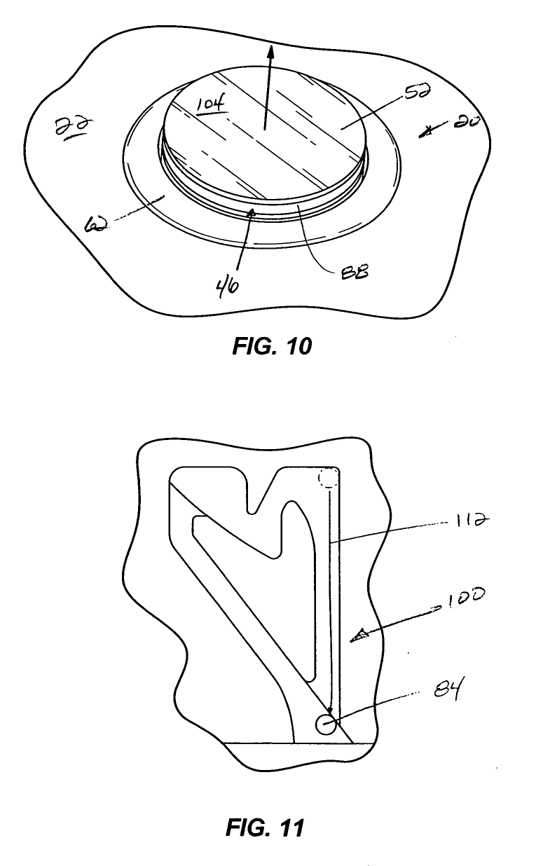

FIGS. 9-11 illustrate the fuel level gauge 46 being transferred from the retracted position to the extended position. Assuming the fuel level gauge 46 has started in the retracted position (FIGS. 7-8), pressing it towards the housing 38 will result in the fuel level gauge 46 being positioned as shown in FIG. 5. In this case, FIG. 9 shows the travel path of the biased pin end 84 along the third track 110 in the pop-up groove 100 corresponding to the position of the fuel level gauge 46 in FIG. 5. Upon release of the gauge 46, it will move to the extended position (FIG. 10). The top surface 104 of the lens 52 will be higher than that of the top surface of the trim ring 62, and the biased pin end 84 will settle to the position in the pop-up groove 100 (FIG. 11) after traveling along the fourth track 112. From this extended position it is possible to remove the fuel level gauge 46 from the housing 38 without the use of tools.

The function of the LEDs 92 is to inform a rider of the quantity of fuel remaining in the tank 14. Each of the LEDs 92 emits light of a first color, such as blue light. When the tank is full, all of the LEDs 92 will be illuminated. As the tank 14 empties, the LEDs 92 will turn off one by one such that the number of LEDs 92 lit indicates the level of fuel within the tank 14. When only one LED 92 remains illuminated, it will change to another color, for example red, indicating to the rider that the fuel tank 14 is nearly empty. In other embodiments, the actual number and color of LEDs 92 can vary.

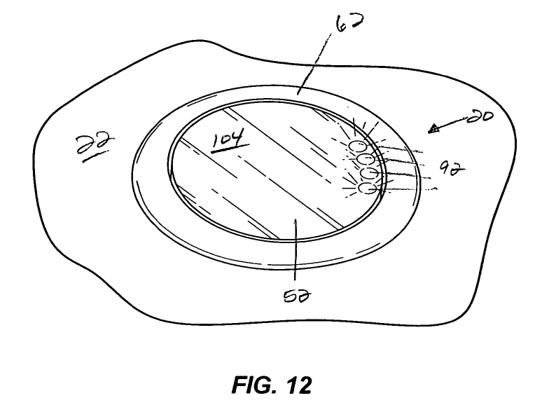

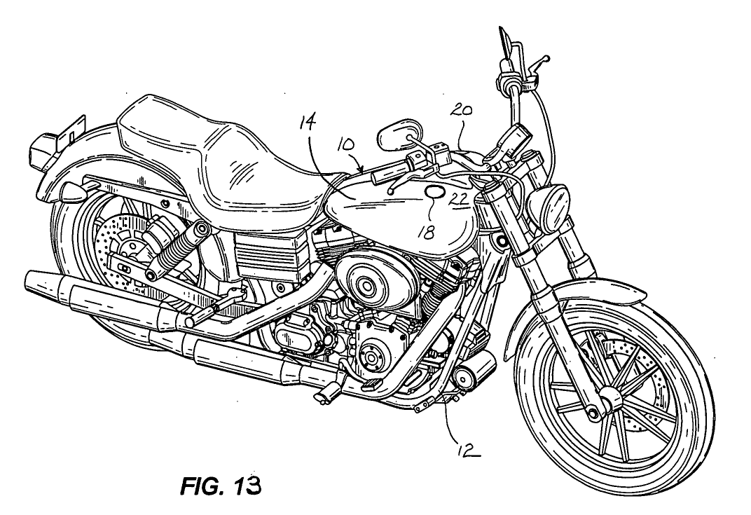

FIG. 12 illustrates the fuel level gauge 46 with some of the LEDs 92 illuminated behind the mirrored lens 52. The chrome plated finish of the mirrored lens 52 is intended to hide the photoelectric sensor 94 and the LEDs 92 when they are not illuminated (FIG. 7). When the LEDs 92 are illuminated, they become visible to the rider through the chrome finish of the mirrored lens 52. The fuel level gauge assembly 20 is oriented in the assembled state such that the LEDs 92 are directed toward the rider of the motorcycle (i.e., directed toward the rear of the motorcycle).

The position of the photoelectric sensor 94 can vary. Its purpose is to measure the amount of ambient light and make the LEDs 92 brighter as necessary so they remain visible to the rider in different lighting conditions.

Thus, the invention provides, among other things, a new and useful fuel level gauge for a motorcycle. More particularly, the invention provides a new and useful fuel level gauge that is aesthetically pleasing, allows the rider to remove it without the use of tools, and wherein the top surface is substantially aligned with the top surface of the fuel tank. Various features and advantages of the invention are set forth in the following claims.

What is claimed is:

1. A fuel gauge assembly for a motorcycle having a fuel tank containing fuel at a level, the fuel gauge assembly comprising:
a housing adapted to be coupled to the fuel tank of the motorcycle, the housing defining an axis; and
a fuel gauge adapted to indicate the level of fuel in the tank, the fuel gauge movable along the axis and relative to the housing between a retracted position wherein the fuel gauge is a first distance from the housing, and an extended position wherein the fuel gauge is a second greater distance from the housing, the fuel gauge being released from the retracted position to allow movement along the axis toward the extended position by moving the fuel gauge along the axis toward the housing.

2. The fuel gauge assembly of claim 1, wherein the fuel gauge comprises a top surface, and wherein the top surface is substantially aligned with a top surface of the fuel tank when the fuel gauge is in the retracted position, and wherein the top surface of the fuel gauge is above the top surface of the fuel tank when the fuel gauge is in the extended position.

3. The fuel gauge assembly of claim 1, wherein the fuel gauge is removable from the housing without the use of tools.

4. The fuel gauge assembly of claim 1, wherein a biasing member exists between the fuel gauge and the housing biasing the fuel gauge away from the housing.

5. The fuel gauge assembly of claim 1, wherein the fuel gauge includes a body having a groove, and wherein the housing includes a biased pin, the fuel gauge being held in the retracted position by the biased pin received within the groove.

6. The fuel gauge assembly of claim 5, wherein the groove includes a first track, the biased pin following the first track when the fuel gauge is moved towards the housing from the retracted position.

7. The fuel gauge assembly of claim 6, wherein the groove includes a second track extending from the first track, the biased pin following the second track when the fuel gauge moves to the extracted position after the fuel gauge is released from the retracted position.

8. A fuel tank assembly for a motorcycle, the fuel tank assembly comprising:
a fuel tank including a top surface and an aperture located in the top surface, the top surface defining a first contour, the fuel tank adapted to contain fuel at a level; and
a fuel gauge adapted to indicate the level of fuel within the fuel tank, the fuel gauge including a top surface defining a second contour, the fuel gauge coupled to the fuel tank and received within the aperture such that the top surface of the fuel tank is substantially aligned with the top surface of the fuel gauge and the first contour matches the second contour.

9. The fuel tank assembly of claim 8, further comprising a housing coupled to the fuel tank and received within the aperture, the housing including a trim ring including an annular top surface that defines a third contour, the fuel gauge received within the housing such that the top surfaces of the fuel tank, the trim ring, and the fuel gauge are substantially aligned and the contours of the first, second, and third surfaces match.

10. A fuel gauge assembly for a motorcycle including a fuel tank adapted to contain fuel at a level, the fuel gauge assembly adapted to be coupled to the fuel tank of the motorcycle and indicate the level of fuel in the fuel tank, the fuel gauge assembly comprising:
a top surface; and
at lease one light emitting diode (“LED”) including an illuminated condition and a non-illuminated condition, the LED emitting light through the top surface of the fuel gauge when the LED is in the illuminated condition.

11. The fuel gauge assembly of claim 10, wherein the at least one LED includes a series of LEDs, each of the LEDs having an illuminated and non-illuminated condition, wherein the number of LEDs in the illuminated condition is adapted to indicate the level of fuel in the fuel tank.

12. The fuel gauge of claim 11, wherein a first of the LEDs is a first color, and the other of the LEDs are a second color, wherein first of the LEDs is the last of the LEDs to remain in the illuminated condition adapted to indicate the level of fuel in the fuel tank.

13. The fuel gauge of claim 12, wherein the first of the LEDs is red and the other of the LEDs are blue.

14. The fuel gauge assembly of claim 10, further comprising a photoelectric sensor positioned to receive ambient light through the top surface of the fuel gauge.

15. The fuel gauge assembly of claim 14, wherein the brightness of the LED can be varied in the illuminated condition, the photoelectric sensor adjusting the brightness of the LED in response to the amount of ambient light received through the top surface of the fuel gauge.

16. The fuel gauge assembly of claim 10, wherein the top surface includes a lens covering the LED.

17. The fuel gauge assembly of claim 16, wherein the lens includes a mirrored finish, the LED adapted to be visible through the lens when the LED is in the illuminated condition and not visible through the lens when the LED is not in the illuminated condition.

18. The fuel gauge assembly of claim 10, wherein the light emitted from the LED is adapted to be directed primarily to a rider of the motorcycle.
